(19) United States
(12) Patent Application Publication
(10) Pub. No.: US 2026/0323234 A1
(43) Pub. Date: Oct. 15, 2026

(54) HEAD-TRACKED SPLIT RENDERING AND HEAD-RELATED TRANSFER FUNCTION PERSONALIZATION

(71) Applicants: Dolby Laboratories Licensing Corporation, San Francisco, CA (US); Dolby International AB, Dublin (IE)

(72) Inventors: Stefan BRUHN, Sollentuna (SE); Rishabh TYAGI, Sydney (AU)

(73) Assignees: Dolby Laboratories Licensing Corporation, San Francisco, CA (US); Dolby International AB, Dublin (IE)

(21) Appl. No.: 19/108,551

(22) PCT Filed: Sep. 11, 2023
(86) PCT No.: PCT/US2023/073857

§ 371 Date: Mar. 4, 2025

Related U.S. Application Data
(60) Provisional application No. 63/405,538, filed on Sep. 12, 2022.
(60) Provisional application No. 63/422,331, filed on Nov. 3, 2022.

(51) Int. Cl. H04S 7/00; G10L 19/008; H04S 1/00

(52) U.S. Cl. CPC H04S 7/303; G10L 19/008; H04S 1/007; H04S 2420/01

(57) ABSTRACT

Systems, methods and computer program products for direction of arrival (DOA) based head-tracked split rendering and head-related transfer function (HRTF) personalization are described. Head-tracked audio rendering is split between two devices. A first device receives a main bitstream representation of encoded audio. A second device tracks head pose information. The first device decodes the main bitstream using a main decoder, and encodes the decoded bitstream into pre-rendered binaural signals and post-render metadata. The second device decodes the pre-rendered binaural signals and post-renderer metadata from the intermediate bitstream, and provides the decoded pre-rendered binaural signals and post-renderer metadata to a lightweight renderer. The lightweight renderer renders the pre-rendered binaural signals into binaural audio based on the post-renderer metadata, the head pose information, generic HRTF, and personalized HRTF.

### CROSS-REFERENCE TO RELATED APPLICATIONS

This application claims priority to U.S. Provisional Application 63/405,538 filed Sep. 12, 2022 and U.S. Provisional Application 63/422,331 filed Nov. 3, 2022, each of which is hereby incorporated by reference in its entirety.

### FIELD OF INVENTION

This disclosure relates to audio processing. In particular, this disclosure relates to audio rendering.

### BACKGROUND

Extended reality, XR, (AR/MR/VR) will increasingly rely on very power limited end devices. Augmented reality, AR, glasses are a prominent example. To make them as lightweight as possible, they cannot be equipped with heavy batteries. Consequently, to enable reasonable operation times, only very complexity constrained numerical operations are possible on the processors included in them. On the other hand, immersive audio is an essential media component of XR services. These services may typically support adjusting the presented immersive audio/visual scene in response to 3DoF or 6DoF user (head) movements. To carry out the corresponding immersive audio renditions as high quality requires typically high numerical complexity.

One potential solution to address this problem is to carry out the rendering not on the device itself but rather on some entity of the mobile/wireless network to which the end-device is connected or on a powerful mobile user equipment (UE) to which the end-device is tethered. In that case, the end-device would for example only receive the already binaurally rendered audio. The 3DoF/6DoF head pose information (head-tracking metadata) would need to be transmitted to the rendering entity (network entity/UE). A problem with this is the latency for transmissions between end-device and network entity/UE, which can be in the order of 100 ms or more. Doing the rendering on the network entity/UE would thus mean that it must rely on outdated head-tracking metadata and that the binauralized audio played out by the end-rendering device is not matching the actual head pose of the head/end-device. This latency is referred to as motion-to-sound latency. If it is too large, the end user will perceive it as quality degradation.

For the video component of the immersive media rendering, this problem is being addressed by split render approaches, where an approximative part of the video scene is rendered by the network entity/UE and final video scene adjustments are done on the end-device. For audio, the field is currently less explored.

### SUMMARY

In various audio services, e.g., immersive voice and audio services (IVAS), it is desirable to be able to track a user's head movement during audio rendering and to adjust the audio accordingly, to give the user an immersive audio experience. This requires immersive audio decoding and binaural rendering using a set of head related transfer functions (HRTFs) where the choice of the specific HRTFs may depend on properties of the immersive audio signal and the user's head movement (or head pose). Depending on the immersive audio format, decoding and head-tracked binaural rendering may be computationally complex operations. For instance, scene-based audio (e.g., higher-order Ambisonics), channel-based audio (e.g., with 7.1.4 channel layout) or object-based audio with many objects may each rely on a large multitude of constituent audio components, which, due to this multitude, are computationally complex to decode and render. This means that decoding a bitstream and binaural rendering in response to the user's head movement requires a large amount of computational processing. The computational complexity requires power and produces heat that may be problematic for small portable devices like AR glasses.

It is an object of the present invention to overcome the problems described herein, and to provide a split rendering, where head pose specific processing may be performed at a second device.

According to some implementations, this and other objects are achieved by a method according to claim 1 or claim 14. According to another implementation, this and other objects are achieved by a user-held device according to claim 22.

Techniques for direction of arrival (DOA) based head-tracked split rendering and head-related transfer function (HRTF) personalization are described. Head-tracked audio decoding and binaural rendering may be split between two or more devices. In some examples, a first device may coordinate split decoding and rendering operations with a second device. The first device, e.g., a smartphone, receives a main bitstream representation of encoded audio. The first device decodes and renders the main bitstream into pre-rendered binaural signals using a main decoder and binaural renderer, and encodes the pre-rendered binaural signals and post-render metadata, including information about the HRTF associated with the binaural rendering. The first device provides the pre-rendered binaural signals and post-renderer metadata to the second device as a multiplexed intermediate bitstream. The second device, e.g., a headphone, AR glasses, or an earbud, tracks current head pose information. The second device decodes the pre-rendered binaural signals and post-renderer metadata from the intermediate bitstream, and provides the decoded pre-rendered binaural signals and post-renderer metadata to a lightweight renderer. The lightweight renderer renders the pre-rendered binaural signals into binaural audio based on the post-renderer metadata, the current head pose information, generic HRTF, and optionally personalized HRTF.

The post-rendering metadata includes at least an indication of the pre-rendering HRTF that has been used in the binaural pre-rendering. The pre-rendering HRTF is associated with a direction of arrival (DOA) of a dominant directional component of the audio content (typically two angles) in relation to an assumed head pose. The indication of the pre-rendering HRTF may be the DOA, or some sort of index, allowing the user-held device to identify the correct HRTF.

In some implementations, the indication of the pre-rendering HRTF also includes one or several parameters that may be personalized.

The rendering may involve calculating a compensated stereo audio signal by applying an HRTF compensation operation, configured to compensate an effect of a pre-rendering HRTF, to the binaural audio signal, and calculating a binaural output signal by applying a post-rendering HRTF to the compensated stereo signal. These steps may be performed in one single operation. The HRTF compensation operation may involve an inverse of the pre-rendering HRTF, e.g. obtained by accessing a look-up table, Other ways to accomplish compensation of the pre-rendering HRTF are also possible.

The binauralization is herein described as being performed using head-related transfer functions (HRTF), but may equally well be performed using binaural room impulse responses (BRIRs). Further, it should be noted that all HRTF processing needs to be performed for each time frame and for each frequency band, often expressed as time/frequency-tiles.

In some applications, also the assumed head pose is included in the metadata. In other implementations, the user-held device is configured to send the current head pose to the main device. Optionally, the second device encodes at least a portion of the head pose information into a head pose bitstream and provides the bitstream to the first device. The first device decodes the head pose bitstream to obtain the head pose information, and then applies the head pose information to the main decoder and pre-renderer. The main decoder/pre-renderer decodes and pre-renders the main bitstream based on the received head pose information (also referred to as assumed head pose) and generic HRTF. In this case, the user-held device can estimate the assumed head pose based on an expected delay of transmission.

Information of the assumed head pose is transmitted together with other information to the second device unless that device derives the assumed head pose from a priori knowledge, which may be based on (head pose) information previously transmitted to the first device or an assumed head pose that is pre-agreed between both devices.

In addition, the present disclosure relates to a further inventive concept, involving techniques for DOA based head-tracked split rendering with a suitable prototype signal and an optional diffused signal. The first device decodes the main bitstream using a main decoder, and renders the decoded bitstream as a dominant directional component, referred to as a prototype signal, and zero or more diffused signals, and post-render metadata. The first device then encodes the prototype signal and zero or more diffused signals (or parameters representing them) and post-renderer metadata and provides it to the second device as a multiplexed intermediate bitstream. The second device decodes the prototype signal and zero or more diffused signals and post-renderer metadata from the intermediate bitstream, and provides the decoded prototype signal and zero or more diffused signals and post-renderer metadata to a lightweight renderer. The lightweight renderer renders the prototype signal and zero or more diffused signals into binaural audio based on the post-renderer metadata, information relating to the head pose, generic HRTF, and optionally personalized HRTF.

The techniques described in this specification can achieve various technical advantages over conventional rendering techniques. Splitting the processing between two devices reduces processing on a wearable device, thereby extending battery life. The wearable device performs lightweight rendering based on the current head pose of the user without having to rely only on a binaural rendition by a heavy-duty rendering device that may only have access to delayed/outdated head pose information, thereby reducing motion-to-sound latency due to the potential use of outdated head pose information during rendering. The allocation of amount of processing between the first device can be flexible, e.g., by tuning the amount of head pose information transmitted from the second device to the first device, from none to entirety, thereby allowing matching various wearable devices with different processing power. Other advantages, features and benefits, other than those explicitly described above, will be apparent in light of the Detailed Description and associated drawings as described below.

This Summary is provided to introduce a selection of concepts in a simplified form and is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF DRAWINGS

FIG. 1 is a block diagram of an example system implementing head-tracked split rendering.

FIG. 2 is a flow chart illustrating processing in a first or main device.

FIG. 3 is a flow chart illustrating processing in a second or user-held device.

FIG. 4 illustrates example techniques of DOA-based split rendering with pre-rendered binaural signal.

FIG. 5 illustrates example techniques of HRTF personalization.

FIG. 6 illustrates example techniques of DOA-based split rendering with prototype signal.

### DETAILED DESCRIPTION

In the following detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The following detailed description is, therefore, not to be taken in a limiting sense, and the scope of the presented concepts is defined only by the appended claims.

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (e.g., a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as ROM, PROM, EPROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

The disclosure assumes that there is an immersive audio codec, such as an IVAS codec, being used in some extended reality, XR, application. The main decoding and pre-rendering may be done by a first device (user equipment, UE) or the Edge or other network node of an assumed 5G system. The second device contains a post decoder and a (lightweight) post renderer. Thus, the overall operations may be divided into operations of multiple devices. The first device (main device) may be a mobile device like a laptop, or tablet, or smartphone, or a stationary device such as a workstation or a server. The first device may also be a combination of several processing devices. The second device may be a user-held (e.g., worn) device, such as a pair of augmented reality, AR, glasses.

One basic assumption and inventive insight applied in the field of split rendering is that, per time-frequency tile, the audio is composed of one dominant directional component and a diffuse (omni-directional) component. The directional component is assumed to be a prototype signal S arriving from a certain direction of arrival (DOA) while the diffuse component is a decorrelated version of that prototype signal. This concept was proven to be very powerful in spatial audio coding approaches like DirAC or metadata assisted spatial audio (MASA) coding.

Based on at least these assumptions, various example implementations may comprise the following steps:

1. The pre-renderer binauralizes the decoded immersive audio using a set of generic HRTFs (or BRIRs) given the head pose P′ that has either been transmitted from the lightweight device equipped with a head-tracker or that may just be a pre-set value that does not necessarily correspond to the any actual head pose of the user, but rather could be a reasonable default, like a straight forward looking head pose. The application of the HRTFs during the binaural pre-rendering operation may be done with a specifically selected HRTF for each time/frequency tile. The HRTFs are selected based on a direction of arrival (DOA) of the dominant component of the immersive audio content, in relation to the assumed head pose.

2. The first or main device encodes and transmits the binauralized audio channels and an indication of the used HRTFs and/or the DOA angles, and the assumed head pose P′.

3. The post-renderer of the second device aims at adjusting the received left and right binaural signals with respect to the current head pose P (if it deviates from P′).

4. Given the HRTFs or DOA angles and head pose applied by the pre-renderer, left and right HRTF-compensated signals are calculated by the second device essentially by inverse HRTF filtering of the left and right audio channels and optionally combining them linearly.

5. The HRTF compensated signals are the filtered by the second device with the correct HRTFs corresponding to the correct head pose.

6. A potential error in the diffuse component is mitigated by proper selection of the weights of the mentioned linear combination.

The main idea can also be applied for HRTF personalization where generic HRTFs are used by the pre-renderer, while the post-renderer compensates for these generic HRTFs and subsequently applies personalized HRTFs.

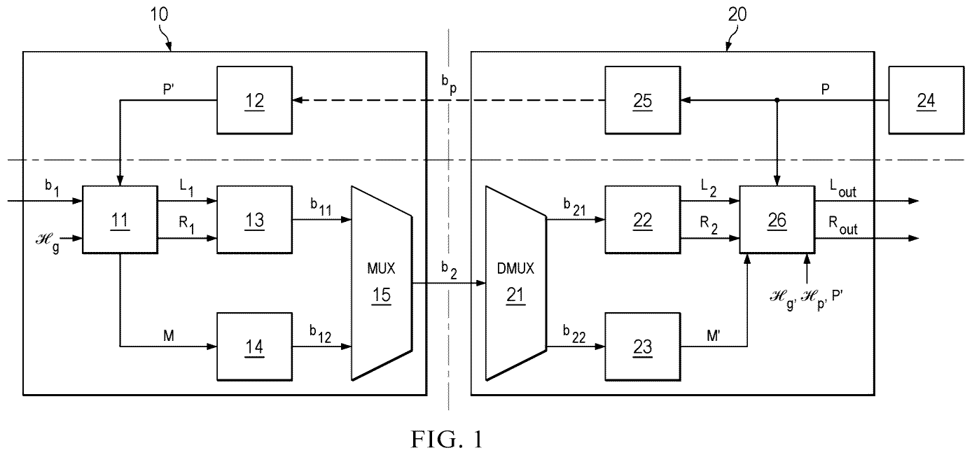

In the following, an example implementation of the novel concepts described herein is illustrated with reference to FIGS. 1-3.

FIG. 1 is a block diagram of an example system implementing head-tracked split rendering arranged in accordance with various aspects of the present invention. The example system includes a first device 10, and a second device 20. The first device 10 may also be referred to as a main device, while the second device 20 may also be referred to as a mobile or user-held device.

In FIG. 1, the first or main device 10 includes a decoder/renderer 11, an optional head pose decoder 12, encoders 13 and 14, and a multiplexer 15. The decoder/renderer 11, e.g., an IVAS decoder, receives (step S1) the main bitstream b₁ including encoded immersive audio content, decodes (step S2) the immersive audio content, and performs binaural rendering (step S3) of the decoded audio content using HRTFs associated with a direction of arrival, DOA relative an assumed head pose P′ of the user. The used HRTFs are typically taken out of a set [symbol] _{g} of generic HRTFs (for various directions of arrival, DOA). It is this processing that is typically too computationally complex to be performed in a mobile or user-held (lightweight) device. The assumed head pose P′ may be an appropriate default head pose or may be an actual user head pose received from the user-held device, which may optionally be decoded by the head pose decoder 12 (step S21). Such a decoded user head pose may represent a recent, but not quite current, head pose of the user. The renderer 11 outputs the binaural signal L₁, R₁ as well as post-rendering metadata M. The post-rendering metadata M includes an indication of the used HRTFs, expressed e.g., as a direction of arrival, DOA, of the dominant directional component of the immersive audio content, expressed in relation to the assumed head pose P′ or an index of the used HRTFs. The post-rendering metadata M may also include an indication of the head pose P′ associated with the binaural rendering. The encoders 13, 14 are arranged to encode (step S4) the binaural signal L₁, R₁ and the post-rendering metadata M, into encoded signals b₁₁ and b₁₂, respectively. The multiplexer 15 is arranged to multiplex or combine (step S5) the encoded binaural signal b₁₁, and the encoded metadata b₁₂, into an intermediate bitstream b₂, which is transmitted (step S6) to the second device 20.

The second device 20, which may be a user-held device 20, includes a demuxer 21, decoders 22 and 23, an encoder 25, a renderer 26, and a head-tracker 24. The user-held device 20 receives (step S11) the intermediate bitstream b₂, and demuxer 21 separates the intermediate bitstream b₂ into encoded signals b₂₁ and b₂₂; which are received by the corresponding decoders 22 and 23. Decoders 22 and 23 responsively decode (step S12) the encoded signals b₂₁ and b₂₂ to obtain a decoded binaural signal L₂, R₂ and decoded metadata M′. As mentioned, the metadata M′ includes in indication of the HRTF used, e.g. indicated by an index or a direction of arrival with respect to a forward looking head pose.

The head-tracker 124, which may be included in the user-held device 120 or be connected thereto, detects (step S13) a current head pose P of the user's head. The encoder 25 may optionally be used to encode (step S131) the detected head pose P as b_{P} and transmit the encoded detected head pose b_{P} to the main device 10.

The metadata M′ may also include the assumed head pose P′ used in renderer 11. Alternatively, in an implementation where the detected head pose P is transmitted to the main device 10, the user-held device can estimate the assumed head-pose based on an expected transmission delay. In principle, the assumed head pose can be assumed to be the head pose detected at a point in time corresponding to the expected transmission delay.

Finally, the renderer 26 receives the decoded binaural audio signal L₂, R₂, the DOA or used HRTFs, the assumed head pose P′ and the current head pose P, and calculates an output binaural signal Lₒᵤₜ, Rₒᵤₜ. This processing involves identifying (step S14) a post-rendering HRTF corresponding to the detected, current head pose P, calculating a compensated stereo audio signal (step S15) by applying an HRTF compensation operation, configured to compensate an effect of the pre-rendering HRTF, to the binaural audio signal, and finally applying (step S16) the identified post-rendering HRTF. For this processing, which will be discussed below, the renderer 26 is provided with HRTF data, typically a set [symbol] of generic HRTFs (for various directions of arrival, DOA). The renderer 26 may also be provided with a set [symbol] of personalized HRTFs.

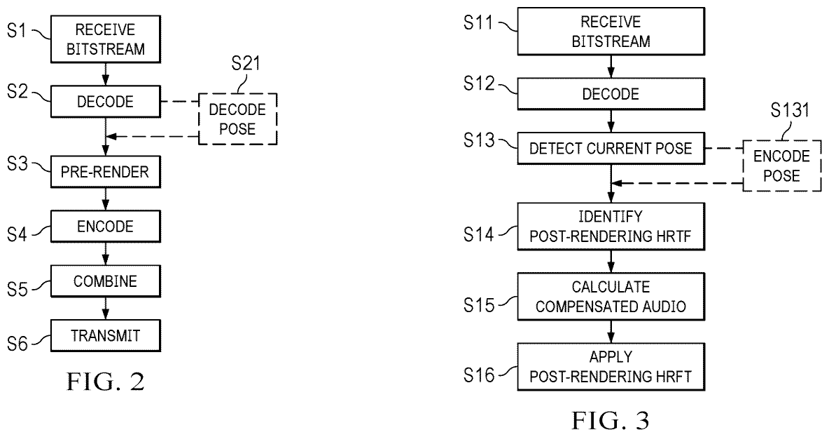

FIG. 2 is a flow chart illustrating processing in a first device (or main device), which includes the above-described steps S1-S6, and optional step S21.

The process includes, at step S1, “receive bitstream”, receiving a bitstream, and at step S2, “decode”, decoding the bitstream by a decoder to obtain decoded immersive audio content. At step S21, “decode pose”, the process may include the optional step of receiving and decoding an indication of a current user head pose from a second, user-held device, and determining the assumed user head pose based on the current user head pose. At step S3, “pre-render”, the process involves binauralizing the immersive audio content by a pre-renderer to generate a pre-rendered binaural signal, the binauralizing using a pre-rendering HRTF out of a set of HRTFs and an assumed head pose of a user. At step S4, “encode”, the process involves encoding the pre-rendered binaural signal, and encoding post-rendering metadata, the metadata indicating the pre-rendering HRTF. At step S5, “combine”, the process involves combining, in a multiplexer, the encoded binaural audio signal and the encoded post-rendering metadata, to form a bitstream including a binaural audio representation. At step S6, “transmit”, the process involves transmitting the bitstream to a second device (or user held device).

FIG. 3 is a flow chart illustrating processing in a second device (or user-held device), which includes above-described steps S11-S16, and optional step S131.

The process includes, at step S11, “receive bitstream”, receiving, from a first device (or main device), a bitstream including a representation of a binaural pre-rendering of an immersive audio content. The binaural pre-rendering has been obtained with respect to an assumed head pose P′. At step S12, “decode”, the process involves decoding the bitstream to obtain a binaural audio signal and associated post-rendering metadata. The metadata is indicating a pre-rendering HRTF used in the binaural pre-rendering, where the pre-rendering HRTF is associated with the assumed head pose P′. At step S13, “detect current pose”, the process involves obtaining user head pose information indicating a current head pose P. At step 131, “encode pose”, the process may include the optional step of encoding the detected head pose P with an encoder, and transmitting an indication of the current head pose P to the main device. As mentioned above, the main device can then use the current pose received from the second, user-held device as assumed pose. Therefore, in this case, the second, user-held device can estimate the assumed head pose P′ based on an expected transmission delay (and a previously transmitted current pose). At step S14, “identify post-rendering HRTF”, the process involves identifying a post-rendering HRTF based on the metadata, the assumed head pose P′ and the current head pose P. At step S15, “calculate compensated audio”, the process involves calculating a compensated stereo audio signal by applying an HRTF compensation operation, configured to compensate an effect of the pre-rendering HRTF, to the binaural audio signal.

Described herein are various example HRTF-compensation operations that are suitable for calculating the compensated stereo audio signal. These operations may involve any number of methods that suitably counter and adjust for various effects resulting from the pre-rendered HRTF operations. In some examples, the HRTF compensation may involve an inverse mathematical operation of the pre-rendering HRTF. In some other examples, the HRTF compensation may be implemented with a look-up table type of operation, where—to reduce memory needs—the lightweight device may rely on a less dense set of HRTFs than used in the pre-rendering device. Hence, the set of inverse HRTFs available to the lightweight device may comprise suitable approximations of the inverses of the HRTFs available in the HRTF set at the pre-rendering device. In still other examples, the HRTF compensation may be implemented with a numerical approximation method that may include interpolation, either linear or non-linear or combinations thereof. In yet further examples, the HRTF compensation may be implemented with a best fit type of approximation. Combinations of various methods are equally applicable and considered within the scope of the present disclosure.

Returning to FIG. 3, at step S16, “apply post-rendering HRTF”, the process involves calculating a binaural output signal by applying the post-rendering HRTF to the compensated stereo signal. Steps S15 and S16 may be performed as a single operation.

The processes illustrated by FIGS. 2 and 3 include a collection of blocks, which represent a sequence of operations or steps that can be implemented in hardware, software, or a combination thereof. In the context of software, the blocks may represent computer-executable instructions that, when executed by one or more processors, perform the recited operations. Generally, computer-executable instructions may include routines, programs, objects, components, data structures, and the like that perform or implement functions. The order in which operations are described is not intended to be construed as a limitation, and any number of the described blocks can be combined in any order, separated into additional blocks, and/or operated in parallel to implement the process.

### Approach at the Pre-Renderer 11:

A basic assumption is that, per time-frequency tile, the audio is composed of one dominant directional component and a diffuse (omni-directional) component. The directional component is assumed to be a prototype signal S arriving from a certain DOA having azimuth and elevation angles α₀,γ₀ expressed in some room coordinate system. The diffuse component is a decorrelated version of the prototype signal S.

Pre-renderer synthesis is here done by convolving the directional component (per time-frequency tile) with HRTFs corresponding to the DOA and adding the diffuse component. Both components are added with respective weights r_{dir} and r_{diff}:

$${L}_{1} = {r}_{dir} S * {h}_{L} ( {α}^{′} , {γ}^{′} ) + {r}_{diff} {Ψ}_{L} ( S ) ,$$

$${R}_{1} = {r}_{dir} S * {h}_{R} ( {α}^{′} , {γ}^{′} ) + {r}_{diff} {Ψ}_{R} ( S ) ,$$

with decorrelators Ψ_{L} and Ψ_{R}.

Here, α′, γ′ are azimuth and elevation angles of the directional component relative to the head pose P′ assumed at the pre-renderer 11. If the head pose P′ is expressed in the same room coordinate system, then, at least under certain further limiting assumptions, α′=α₀−α_{P′}, γ′=γ₀−γ_{P′}.

### Approach at the Post-Renderer:

The post-renderer aims at adjusting the received left and right binaural signals L₂ and R₂ with respect to the current head pose P, if it deviates from P′.

An important insight is that the correct output signal would be

$${L}_{out}^{*} = {r}_{dir} S * {h}_{L} ( α , γ ) + {r}_{diff} {Ψ}_{L} ( S ) ,$$

$${R}_{out}^{*} = {r}_{dir} S * {h}_{R} ( α , γ ) + {r}_{diff} {Ψ}_{R} ( S ) .$$

The signal S and the decorrelator signals Ψ_{L} and Ψ_{R} are unavailable. Instead, Lₒᵤₜ* and Rₒᵤₜ* will be approximated in a parametric approach using available signals L₂ and R₂. Assuming that the HRTFs applied by the pre-renderer are known, left and right HRTF-compensated signals can be calculated. One possibility to obtain these signals is to derive them as a weighted combination of the HRTF compensated left and right channel signals. Hereby, κ_{L} and κ_{R} are suitable weighting factors or operators.

The HRTF compensated left and right channel signals are

$${L}_{2} * {h}_{L}^{- 1} ( {α}^{′} , {γ}^{′} )$$

and, respectively,

$${R}_{2} * {h}_{R}^{- 1} ( {α}^{′} , {γ}^{′} )$$

for left and right channel signals.

The left and right HRTF-compensated signals are then

$${L}_{C} = {κ}_{L} {L}_{2} * {h}_{L}^{- 1} ( {α}^{′} , {γ}^{′} ) + ( 1 - {κ}_{L} ) {R}_{2} * {h}_{R}^{- 1} ( {α}^{′} , {γ}^{′} )$$

$$and$$

$${R}_{C} = ( 1 - {κ}_{R} ) {L}_{2} * {h}_{L}^{- 1} ( {α}^{′} , {γ}^{′} ) + {κ}_{R} {R}_{2} * {h}_{R}^{- 1} ( {α}^{′} , {γ}^{′} ) .$$

In one simple example, κ_{L}=κ_{R}=1 (no weighting), such that

$${L}_{C} = {L}_{2} * {h}_{L}^{- 1} ( {α}^{′} , {γ}^{′} ) ,$$

$$and$$

$${R}_{C} = {R}_{2} * {h}_{R}^{- 1} ( {α}^{′} , {γ}^{′} ) .$$

Using these signals, left and right output signals of the post-renderer are obtained as follows:

$${L}_{out} = {h}_{L} ( α , γ ) * {L}_{C}$$

$$and$$

$${R}_{out} = {h}_{R} ( α , γ ) * {R}_{C} .$$

This approach leads to correct directional components in the output signals with regards to the present head pose, i.e. r_{dir} S*h_{L}(α,γ) and r_{dir} S*h_{R}(α,γ).

However, there occurs an error in the diffuse components that can be quantified as follows:

$$Δ {L}_{diff} = {r}_{diff} [ ( {κ}_{L} {h}_{L}^{- 1} ( {α}^{′} , {γ}^{′} ) * {Ψ}_{L} ( S ) + ( 1 - {κ}_{L} ) {h}_{R}^{- 1} ( {α}^{′} , {γ}^{′} ) * {Ψ}_{R} ( S ) ) * {h}_{L} ( α , γ ) - {Ψ}_{L} ( S ) ]$$

$$and$$

$$Δ {R}_{diff} = {r}_{diff} [ ( 1 - {κ}_{R} ) {h}_{L}^{- 1} ( {α}^{′} , {γ}^{′} ) * {Ψ}_{L} ( S ) + {κ}_{R} {h}_{R}^{- 1} ( {α}^{′} , {γ}^{′} ) * {Ψ}_{R} ( S ) ) * {h}_{R} ( α , γ ) - {Ψ}_{R} ( S ) ] .$$

Assuming a possible decomposition of the HRTFs into delay and gain/shape operations, the involved delay change of the decorrelated diffuse component may perceptually not matter, the gain/shape change may lead to timbral deviations or coloration effects. It is possible to mitigate this error by proper choice of KL, KR given the involved set of HRTFs. In a more generic form κ_{L}, κ_{R} can be linear and non-linear operators like (frequency selective) filter operators or gain limiters to avoid the output samples exceeding a predetermined number range.

The benefits of selecting the weights κ_{L}, κ_{R} adaptively is illustrated by example considering a case where head pose changes are limited to yaw, i.e., rotations occur only around the z-axis and thus the elevation angles of the directional components with regards to assumed and present head poses are equal (γ=γ′).

Considering firstly the case where there is almost no yaw rotation. Thus, α approximately equals α′. In this case, the weights are preferably chosen according to κ_{L}=κ_{R}=1, which means that the received left and right binaural signals L₂ and R₂ are output almost without modification and ΔL_{diff}≈ΔR_{diff}≈0. Thus, for (sufficiently) small yaw deviations (e.g., less than 20 degrees), setting the weights to κ_{L}=κ_{R}=1 is a good choice.

Considering secondly the case where there is a yaw change by 180, resulting in α approximately equaling α′±180 degrees. Now, the weights are preferably chosen according to κ_{L}=κ_{R}=0, which means that the received left and right binaural signals L₂ and R₂ are (virtually) swapped as part of the adjustment processing. This results in the following diffuse components for left and right output channels:

$${L}_{out , diff} \approx {r}_{diff} {h}_{R}^{- 1} ( α \pm 1 \; 80 , γ ) * {h}_{L} ( α , γ ) * {Ψ}_{R} ( S ) ,$$

$$and$$

$${R}_{out , diff} \approx {r}_{diff} {h}_{L}^{- 1} ( α \pm 1 \; 80 , γ ) * {h}_{R} ( α , γ ) * {Ψ}_{L} ( S ) .$$

Considering that right-ear HRTFs can be approximated with left-ear HRTFs taken with 180 degree azimuthal offset, and likewise that left-ear HRTFs can be approximated with right-ear HRTFs taken with 180 degree azimuthal offset, it is found that in the equations above, the terms

$${h}_{R}^{- 1} ( α \pm 1 \; 80 , γ ) * {h}_{L} ( α , γ ) {h}_{L}^{- 1} ( α \pm 1 \; 80 , γ ) * {h}_{R} ( α , γ )$$

can be approximated with 1. This leads to the following approximation of the diffuse components for left and right output channels:

$${L}_{out , diff} \approx {r}_{diff} * {Ψ}_{R} ( S ) ,$$

$$and$$

$${R}_{out , diff} \approx {r}_{diff} * {Ψ}_{L} ( S ) .$$

It can thus be concluded that setting the weights to κ_{L}=κ_{R}=0 is a good choice if the yaw difference between the present and the assumed head poses is close to 180 degrees.

A third considered case is where there is a yaw rotation by 90, resulting in that α equals α′±90 degrees. Now, it can be argued that there is no reason to give preference to either available signals L₂ or R₂ when constructing the HRTF-compensated signals. This is because this could potentially lead to solutions with asymmetric behavior between left and right channels.

Symmetric behavior is achieved when choosing κ_{L}=κ_{R}=0.5 in case of yaw rotations close to 90 degrees.

This discussion leads to a preferred solution for adaptively selecting the weights κ_{L}, κ_{R} in response to a determined yaw rotation Δ_{yaw}, i.e., the difference between azimuth angles of the directional component relative to the assumed head pose P′ and the present head pose P:

$${κ}_{L} = {κ}_{R} = \frac{1}{2} ( 1 + cos ( {Δ}_{yaw} ) ) .$$

Note that analogous embodiments can be formulated based on the roll angles of the assumed and the present head poses.

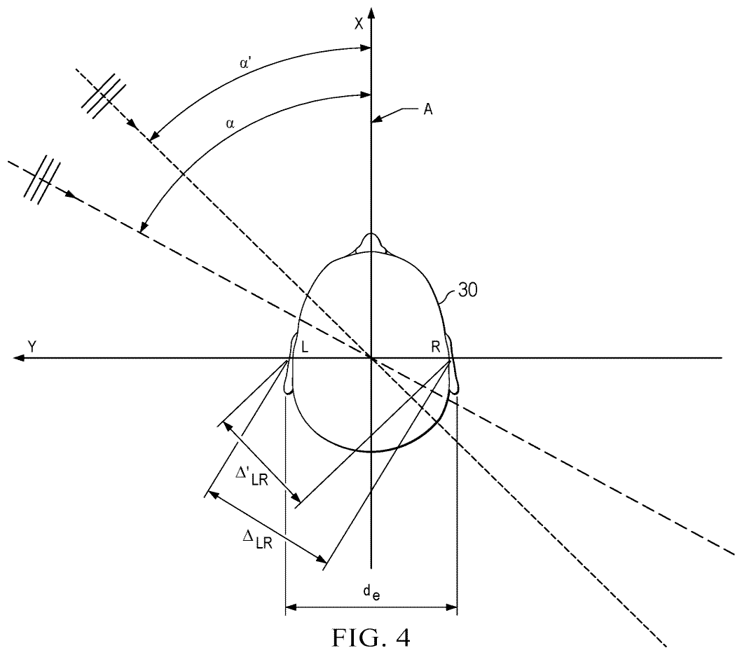

FIG. 4 illustrates example techniques of DOA-based split rendering with pre-rendered binaural signals. It is shown how acoustical wavefronts are assumed to arrive to the head 30 of a listener from a DOA having azimuthal angles α′, respectively, α. The pre-renderer has only access to head pose P′ with angle α′. Thus, the binaural synthesis is done using HRTFs corresponding to head pose P′ with angle α′. One main effect is that the interaural time difference (ITD) of the wavefront between left and right ears is

$${Δ}_{LR}^{′} .$$

There are also corresponding interaural level differences (ILD) and spectral differences. The applied HRTFs mimic this effect by imposing/imprinting suitable ITDs, ILDs and spectra. The figure shows further the assumed situation at the post-renderer that has knowledge of the actual head pose P with angle α. It is shown how the assumed wavefront arrives from a different DOA with respect to the actual head pose P—angle α instead of α′—which in turn results in a different ITD Δ_{LR}. Notably, there are also other ILDs and spectra corresponding to the actual head pose. One main concept of the disclosure visualized in FIG. 4 is thus to change the ITD from Δ_{LR}′ to Δ_{LR} by first compensating Δ_{LR}′ and then applying Δ_{LR}. Similarly, ILD and spectra are modified by compensating those corresponding to the head pose P′ and the applying ILD and spectra of the HRTFs corresponding to the actual head pose P.

The above description leads to the following simplified approach (also making reference to FIG. 4):

### Assumptions:

The back-front axis A of the listener 30 defines the x-axis of a right-handed coordinate system. Furthermore, in many relevant cases, a user may mostly made head movements around the yaw-axis (z-axis) and most immersive audio content has sound sources that are close to the horizontal plane. Thus, the elevation angle of the DOA is relatively close to zero degrees (e.g. bound withing the interval of [−20,20] degrees).

Under these assumptions, according to a simplified formulation, only the azimuthal component of the DOA gives rise to significant ITD. It further influences gain and spectral shape.

The bounded elevation component of the DOA (pitch, roll) influences gain and spectral shape but not the ITD.

The HRTF filter can be decomposed to a delay and a gain/shape operation:

$${h}_{L} ( {α}^{′} , {γ}^{′} ) = {δ}_{L} ( {α}^{′} ) * {gs}_{L} ( {α}^{′} , {γ}^{′} ) , {h}_{R} ( {α}^{′} , {γ}^{′} ) = {δ}_{R} ( {α}^{′} ) * {gs}_{R} ( {α}^{′} , {γ}^{′} ) .$$

A head pose P′ of the listener is assumed while pre-rendering. The pre-renderer renders under an azimuthal component of the DOA a′ which deviates from the true azimuth a at playback time.

The post-renderer renders under the azimuthal component of the DOA a corresponding to the listener head pose P at playback time.

The inter-aural time differences (ITD) of the pre-rendered signal and the signal after post-renderer adjustments are calculated as follows:

$$\begin{matrix}Δ LR = - \frac{1}{c} {d}_{e} sin ( α ) , \\ {Δ}^{′} LR = - \frac{1}{c} {d}_{e} sin ( {α}^{′} ) ,\end{matrix}$$

with dₑ: inter-aural distance and c: speed of sound.

Consequently, the post-renderer should adjust the ITD of the directional component in a given time-frequency tile from

$${Δ}_{LR}^{′} to {Δ}_{LR} .$$

Apart from ITD adjustments, the post-renderer also adjusts inter-aural level differences and spectral shape given the true head pose compared to the assumed head pose by the pre-renderer.

It is notable, that similar formulations are possible even without the assumption of a bounded elevation component of the DOA. Even in that case, the post-renderer operations can be decomposed to ITD adjustments, inter-aural level differences and spectral shape adjustment. In that case, the amount of required ITD adjustment will however depend on azimuth and elevation angles of the DOA assumed while pre-rendering and effective during post-rendering.

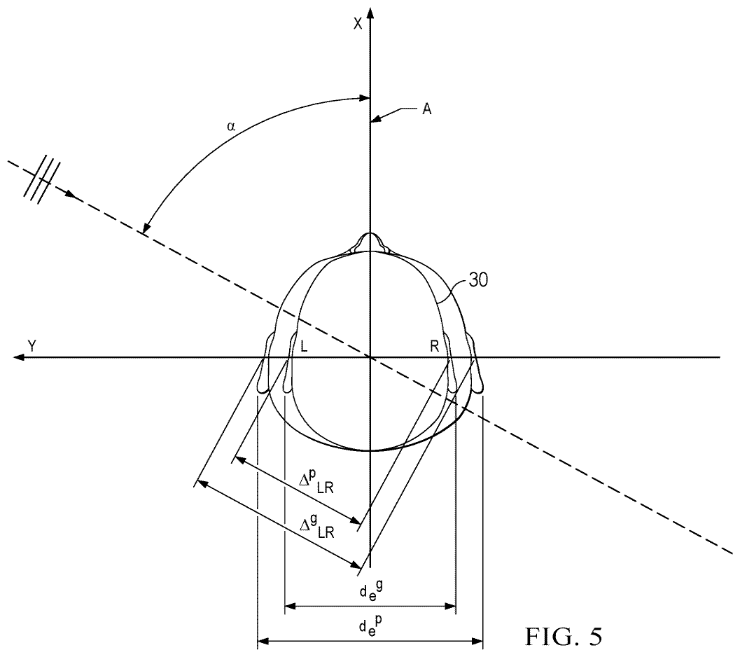

FIG. 5 illustrates example techniques of HRTF personalization. It is shown how an assumed wavefront from arriving at the head 30 of a listener from DOA angle α results in different ITDs depending on the size of the listener head. Pre-rendering with generic HRTFs may assume a listener head dimension with generic inter-aural distance

$${d}_{e}^{g} .$$

This will result in generic ITDs corresponding to

$${Δ}_{LR}^{g}$$

and corresponding ILDs and spectral shapes of left and right audio signals. Personalized HRTFs would be based on (more) correct listener head dimensions. Accordingly, this would result in more correct, personalized, ITDs

$${Δ}_{LR}^{p}$$

and more correct corresponding ILDs and spectral shapes of left and right audio signals. The general idea of the HRTF personalization is that the post-renderer will compensate for the generic HRTFs and impose the effect of the personalized HRTFs. The gross concept is very similar to the above-described head pose correction at the post renderer. Accordingly, both concepts are compatible with each other and can be combined easily.

The same description as above for the main device 10 with pre-renderer 11 applies. However, while the pre-renderer 11 renders relying on a set of generic HRTFs [symbol] _{g}, the post-renderer 26 in the user held device 20 makes adjustments using a set of personalized HRTFs [symbol] ₚ whereby the post-renderer is aware of the generic HRTFs that were used by the pre-renderer.

The post-renderer 26 aims at adjusting the received left and right binaural signals L₂ and R₂ with respect to the current head pose P, if it deviates from P′, and with respect to the set of personalized HRTFs [symbol] ₚ.

The correct output signal would be

$${L}_{out}^{*} = {r}_{dir} S * {h}_{p , L} ( α , γ ) + {r}_{diff} {Ψ}_{L} ( S ) , {R}_{out}^{*} = {r}_{dir} S * {h}_{p , R} ( α , γ ) + {r}_{diff} {Ψ}_{R} ( S ) .$$

The signal S and the decorrelator signals Ψ_{L} and Ψ_{R} are unavailable. Instead,

$${L}_{out}^{*} and {R}_{out}^{*}$$

will be approximated in a parametric approach using available signals L₂ and R₂. Assuming that the HRTFs applied by the pre-renderer are known, left and right HRTF-compensated signals are calculated as a linear combination of the HRTF compensated left and right channel signals:

$$\begin{matrix}{L}_{C} = {κ}_{L} {L}_{2} * {h}_{g , L}^{- 1} ( {α}^{′} , {γ}^{′} ) + ( 1 - {κ}_{L} ) {R}_{2} * {h}_{g , R}^{- 1} ( {α}^{′} , {γ}^{′} ) and \\ {R}_{C} = ( 1 - {κ}_{R} ) {L}_{2} * {h}_{g , L}^{- 1} ( {α}^{′} , {γ}^{′} ) + {κ}_{R} {R}_{2} * {h}_{g , R}^{- 1} ( {α}^{′} , {γ}^{′} ) .\end{matrix}$$

Using these signals, left and right output signals of the post-renderer are obtained as follows:

$${L}_{out} = {h}_{p , L} ( α , γ ) * {L}_{C} and {R}_{out} = {h}_{p , R} ( α , γ ) * {R}_{C} .$$

This approach leads to correct directional components in the output signals with regards to the actual head pose and the personalized HRTFs, i.e. r_{dir} S*h_{p,L}(α,γ) and r_{dir} S*h_{p,R}(α,γ).

However, again, there occurs an error in the diffuse components that can be quantified as follows:

$$\begin{matrix}Δ {L}_{diff} = {r}_{diff} [ ( {κ}_{L} {h}_{g , L}^{- 1} ( {α}^{′} , {γ}^{′} ) * {Ψ}_{L} ( S ) + ( 1 - {κ}_{L} ) {h}_{g , R}^{- 1} ( {α}^{′} , {γ}^{′} ) * {Ψ}_{R} ( S ) ) * {h}_{p , L} ( α , γ ) - {Ψ}_{L} ( S ) ] and \\ Δ {R}_{diff} = {r}_{diff} [ ( ( 1 - {κ}_{R} ) {h}_{g , L}^{- 1} ( {α}^{′} , {γ}^{′} ) * {Ψ}_{L} ( S ) + {κ}_{R} {h}_{g , R}^{- 1} ( {α}^{′} , {γ}^{′} ) * {Ψ}_{R} ( S ) ) * {h}_{p , R} ( α , γ ) - {Ψ}_{R} ( S ) ] .\end{matrix}$$

Assuming a possible decomposition of the HRTFs into delay and gain/shape operations, the involved delay change of the decorrelated diffuse component may perceptually not matter, the gain/shape change may lead to timbral deviations or coloration effects. It is possible to mitigate this error by proper choice of KL, KR given the involved set of HRTFs. The embodiments with adaptive selection of the weights in response to the deviation of yaw and/or roll between the present and the assumed head poses remain fully applicable.

### SPECIFIC ASPECTS OF THE EMBODIMENTS

The post-renderer receives direction of arrival (DOA) information. This DOA information may be represented as azimuth and elevation angles (DOA angles) α′, γ′ of the dominant directional component of the immersive audio content in relation to the assumed head pose P′. It should be noted that the DOA is determined per time-frequency tile. Indexes of the used HRTFs are another form to provide the DOA information to the post-renderer.

Further, the post-renderer must be aware of the head pose P′ assumed at pre-renderer. Corresponding information may be transmitted to the post-renderer (i.e., in the metadata). It is also possible to rely on the fact that P′ corresponds to the true head pose at an earlier time instant, which has been transmitted from the post-renderer to the pre-renderer. Assuming the transmission delay from post-renderer to pre-renderer is a priori known or can be estimated, this would make the transmission of P′ to the post-renderer unnecessary. One way to estimate the transmission delay from post-renderer to pre-renderer is to base it on round-trip delay measurements from post-renderer to pre-renderer and back to post-renderer, e.g., using time stamps.

The parameters r_{dir}, r_{diff}, κ_{L}, κ_{R} are mathematically inter-connected. There is thus the possibility to exploit this inter-dependency, which for example help finding suitable choices of κ_{L}, κ_{R} with which it may be possible to avoid using a decorrelator in the post-renderer. The benefit of such an approach is the avoidance of post-renderer complexity.

If a decorrelator should be used in the post-renderer, a suitable decorrelator input signal is

$$D = {L}_{1}^{′} * {h}_{L}^{- 1} ( {α}^{′} , {γ}^{′} ) - {R}_{1}^{′} * {h}_{R}^{- 1} ( {α}^{′} , {γ}^{′} )$$

which compensates/removes the directional component, as it yields:

$$D = {r}_{diff} ( {Ψ}_{L} ( S ) * {h}_{L}^{- 1} ( {α}^{′} , {γ}^{′} ) - {Ψ}_{R} ( S ) * {h}_{R}^{- 1} ( {α}^{′} , {γ}^{′} ) ) .$$

Preferably, pre-rendered binaural channel signals L₁, R₁ are transmitted in complex-valued quadrature mirror filterbank (CQMF)/frequency domain, which would avoid doing a forward time-to-CQMF/frequency domain operation in the post renderer, which would be advantageous in terms of complexity and delay.

A notable difference between the present approach and conventional techniques is that the present approach relies on compensation of the HRTF filter operations of the pre-renderer and applying the HRTFs that would ideally have been used. In contrast, alternative techniques rely on transforming the binaural output channels using a linear transform whose coefficients are obtained following an LMS approach and interpolation.

An example implementation for DOA-based split rendering with prototype signal comprises the following steps:

1. The pre-renderer or decoder generates a prototype signal(S). Some example approaches to generate S are as follows:
a. Get the Ambisonics W or omni directional channel representation from the decoder output with any of the known techniques and use that as S.
b. Get a representation of dominant eigen signal from the decoder output and use that as S.
c. Pre-render the decoded immersive audio using a set of generic HRTFs (or BRIRs), generate S=aL+bR; where in L and R are the Left and Right channels of the pre-rendered bin signal, a and b are complex or real-only gain factors per time-frequency tile and can be either dynamically computed or statically predetermined values, e.g. a=0.5 and b=0.5.

2. The main device transmits the coded prototype signal S and, the assumed head pose P′ and/or the assumed DOA angles (or equivalent information) and diffuseness parameters.

3. The post-renderer decodes the prototype signal bits and generates S′ (which should be same as S if the codec used to code S has zero delay and is lossless).

4. The post-renderer aims at generating left and right binaural signals with respect to the current head pose P (if it deviates from P′).

4. The post-renderer adjusts the DOA angles sent by the main device based on the difference between P and P′. Together with S′, HRTFs at post renderer, and adjusted DOA angles, the post-renderer generates directional components of the post rendered binaural signal. Diffuseness parameters are used with decorrelated S′ to fill in the diffused energy in the post rendered binaural signal.

### Approach at the Post-Renderer:

The post-renderer aims at adjusting the received DOA with respect to the current head pose P, if it deviates from P′ and then together with prototype signal S′ and set of HRTFs [symbol] ₚ which may be personalized or generic. The post-renderer generates the head-tracked binaural signal as follows.

$$\begin{matrix}α = {α}^{′} - ( {α}_{P} - {α}_{{P}^{′}} ) , γ = {γ}^{′} - ( {γ}_{P} - {γ}_{{P}^{′}} ) . \\ {L}_{out}^{*} = {r}_{dir} {S}^{′} * {h}_{p , L} ( α , γ ) + {r}_{diff} {Ψ}_{L} ( {S}^{′} ) , {R}_{out}^{*} = {r}_{dir} {S}^{′} * {h}_{p , R} ( α , γ ) + {r}_{diff} {Ψ}_{R} ( {S}^{′} ) .\end{matrix}$$

r_{diff} is the diffuseness parameter sent by main device and r_{dir} is the directional gain which can be computed with DOA and spherical harmonics.
Pros of this Approach:
Low bitrate mode can be achieved with only S channel being coded and transmitted to post renderer.
HRTFs compensation does not need to happen and error in diffuseness compensation can be reduced to 0.
   Cons of this Approach:
No pre-rendered binaural audio signal is readily available at user-held device for a potential case where the user-held device would only output the decoded binaural audio signal without any further processing or post-rendering operation.

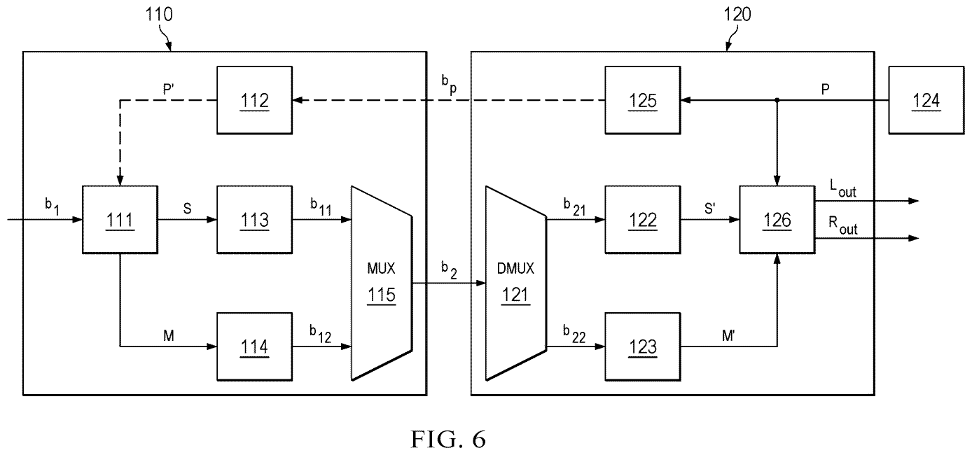

FIG. 6 illustrates example techniques of DOA-based split rendering with prototype signal.

In FIG. 6, the main device 110 includes a decoder/renderer 111, a head pose decoder 112, encoders 113, 114 and a multiplexer 115. The decoder/renderer 111, e.g., an IVAS decoder, receives the main bitstream b₁ and performs rendering synthesis of a prototype signal S, having a direction of arrival, DOA, in relation to an assumed head pose P′ of the user. The assumed head pose P′ may be an appropriate default head pose or may be an actual user head pose received from the user-held device, which may optionally be decoded by the head pose decoder 112. Such a decoded user head pose will represent a recent, but not quite current, head pose of the user. The renderer 111 here outputs a prototype signal S and metadata M including at least the direction of arrival, DOA, of the prototype signal. The encoders 113, 114 encode the prototype signal S and the metadata M, and the multiplexer 115 multiplexes the encoded prototype signal b₁₁ and encoded metadata b₁₂ into one intermediate bitstream b₂.

The user-held device 120 includes a demuxer 121, decoders 122, 123, a head-tracker 124, an encoder 125, and a post-renderer 126. The demuxer 121 receives the intermediate bitstream and separates it into two encoded signals b₂₁ and b₂₂, and the two decoders 122, 123 responsively decode these signals to obtain a decoded prototype signal S′ and decoded metadata M′, e.g., the DOA and (optionally) assumed head pose P′ used in renderer 111. The head-tracker 124, which may be included in the user-held device 120 or be connected thereto, detects a current head pose P of the user's head. The encoder 125 encodes the detected head pose P and transmits it to the main device 110. Finally, the post-renderer 126 receives the decoded prototype signal S′, the DOA, the assumed head pose P′ and the current head pose P, and calculates an output binaural signal Lₒᵤₜ, Rₒᵤₜ. For this processing, which will be discussed below, the post-renderer 126 is provided with HRTF data, typically a set [symbol] _{g} of generic HRTFs (for various directions of arrival, DOA). The renderer 125 may also be provided with a set [symbol] ₚ of personalized HRTFs.

Example Use Cases that can Benefit from Split Rendering of Immersive Audio

The techniques described in this specification can be implemented in various use cases. It is assumed that primary audio processing/audio signal augmentation with subsequent pre-rendering is done at some powerful device or network node while post-rendering is done at a lightweight end-device like AR glasses.

Some examples are provided below.

### 1. AR/MR Involving Audio

Audio zoom/magnifier: Like magnifying glasses but for sound. The user may zoom in on sounds of interest.

Overlay of real-world objects with sounds: Real-world objects/items will be associated with sounds. Useful but not limited to assistance systems for sight-impaired persons.

Dialog enhancement/smart ambient noise reduction: Help for people with cocktail party problem, lifting the active voices over the ambient noise.

Mood sound ambiance: Like mood light. Sound will be associated with real-world environment, items and personal preference.

### 2. Use Case Characteristics

These use cases will typically rely on audio/visual capture, some scene analysis and generation of the augmented sound signal. In some scenarios, it may also be overlaid with immersive sound from some network node or the far end in a communication.

The use cases will typically rely on head-tracked audio/visual rendering.

### 3. Further Non-AR/MR Use Cases

Immersive voice communication (2-party, conferencing) and immersive content streaming with AR glasses as end device are likely IVAS use cases.

Some of them may rely on head-tracked audio rendering, some may not.

Some use cases may involve one-to-many immersive distribution of head-tracked audio.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art.

Therefore, the scope of the appended claims should be accorded the broadest interpretation so as to encompass all such modifications and similar arrangements.

Further details and embodiments of the present invention may be understood from the following list of enumerated exemplary embodiments, EEEs:

EEE1. A method of processing audio, comprising:
receiving, by a first device, a main bitstream representation of encoded audio;
obtaining, by a second device, user head pose information;
determining, by the first device from the main bitstream, downmixed signals comprising at least one channel and metadata;
providing, by the first device to a second device, the downmixed signals and metadata;
rendering, by a lightweight renderer of the second device, the downmixed signals into output binaural audio based on the metadata, the user head pose information.

EEE2. The method of EEE1, wherein the downmixed signals comprise pre-rendered binaural signals.

EEE3. The method of EEE2, wherein determining the pre-rendered binaural signals and rendering metadata comprises:
decoding the main bitstream representation by a main renderer of the first device to generate decoded audio;
binauralizing the decoded audio by a pre-renderer of the first device to generate the pre-rendered binaural signals and rendering metadata, wherein the pre-renderer performs the binauralizing using at least one of:
   a generic head-related transfer function (HRTF) or binaural room impulse response (BRIR), or
   the user head pose information, the user head pose information the user information being obtained from at least one of:
      a head tracker of the second device,
      a storage device storing a pre-set value, or
      an assumed direction of arrival (DOA) angle.

EEE4. The method of EEE3, wherein the metadata includes at least one of:
an indication of an HRTF or a BRIR used by the pre-renderer,
an assumed user head pose used by the pre-renderer, or
the assumed DOA angle used by the pre-renderer.

EEE5. The method of EEE 4, wherein rendering the pre-rendered binaural signals into output binaural audio comprises adjusting, by the lightweight renderer, left and right channels of the pre-rendered binaural signals with respect to a current user head pose obtained through the head tracker over the assumed user head pose used by the pre-renderer.

EEE6. The method of any of EEE2-5, wherein rendering the pre-rendered binaural signals comprises:
inverse HRTF filtering left and right channels of the pre-rendered binaural signals according the HRTF or assumed DOA angle used by the pre-renderer; and
linearly combining the inverse HRTF filtered signals.

EEE7. The method of EEE6, wherein the inverse HRTF filtering includes correcting the HRTF used by the pre-renderer using a current user head pose obtained through the head tracker of the second device.

EEE8. The method of EEE6 or 7, wherein linearly combining the inverse HRTF filtering signals includes mitigating an error in a diffuse component by selecting a weight of the linear combining.

EEE9. The method of any of claims 2-8, comprising applying HRTF personalization, wherein the pre-render applies a generic HRTF, and the light-weight renderer compensates for the generic HRTF and subsequently applies a personalized HRTF.

EEE10. The method of EEE1, wherein the downmixed signals comprise a prototype signal.

EEE11. The method of EEE10, wherein the prototype signal comprises a single channel.

EEE12. The method of EEE10 or 11, wherein computing the prototype signal comprises:
decoding the main bitstream representation by a main decoder of the first device to generate decoded audio; and
applying gains to the decoded audio and adding the decoded audio with applied gains to the decoded audio.

EEE13. The method of any of EEE10-12, comprising:
computing the prototype signal and DOA angles based on assumed head pose P′ and diffuseness parameters;
sending the assumed head pose P′, DOA angles for the assumed head pose P′, diffuseness parameters and the prototype signal to a post renderer device;
   adjusting at the post renderer device, the DOA angles based on an actual head pose P;
computing the directional components using the prototype signal and a set of HRTFs and adjusted DOA angles;
computing diffused components using the diffuseness parameters and a decorrelated version of prototype signal; and
adding directional and diffused components to generate a post-rendered binaural output.

EEE14. The method of any of EEE1-13, wherein the first device comprises a smartphone, the second device comprises a wearable audio, visual, or AR device, and the main bitstream comprises an immersive audio and video services (IVAS) bitstream.

EEE15. A system including one or more processors configured to perform operations of any one of EEE1-14.

EEE16. A computer program product configured to cause one or more processors to perform operations of any one of EEE1-14.

1. A method of processing audio in a user held processing device, comprising:
receiving, from a main device, a bitstream including a representation of a binaural pre-rendering of an immersive audio content, wherein said binaural pre-rendering has been obtained with respect to an assumed head pose P′;
decoding the bitstream to obtain a binaural audio signal and associated post-rendering metadata, said metadata indicating a pre-rendering HRTF used in the binaural pre-rendering, wherein said pre-rendering HRTF is associated with the assumed head pose P′;
obtaining user head pose information indicating a current head pose P;
identifying a post-rendering HRTF based on the metadata, the assumed head pose P′ and the current head pose P;
calculating a compensated stereo audio signal by applying an HRTF compensation operation, configured to compensate an effect of the pre-rendering HRTF, to the binaural audio signal; and
calculating a binaural output signal by applying said post-rendering HRTF to the compensated stereo signal.

2. The method of claim 1, wherein the steps of calculating a compensated stereo audio signal and calculating a binaural output signal are performed in one single operation.

3. The method of claim 1, wherein the HRTF compensation operation involves an inverse of the pre-rendering HRTF.

4. The method of claim 3, wherein the inverse of the pre-rendering HRTF is obtained by accessing a look-up in a table comprising an approximation of an inverse of the pre-rendering HRTF.

5. The method of claim 3, wherein the step of calculating a compensated stereo audio signal includes:
applying an inverse left HRTF to a left channel of the binaural audio signal to form an inverse filtered left channel, applying an inverse right HRTF to a right channel of the binaural audio signal to form an inverse filtered right channel, and combining the inverse filtered left and right channels to form a left channel and a right channel of the compensated stereo audio signal, respectively.

6. The method of claim 5, wherein the inverse filtered left and right channels are linearly combined, with weights of the linear combining are selected to mitigate an error in a diffuse component of the binaural output signal.

7. The method of claim 6, wherein the weights are adaptive, preferably in response to a difference between assumed head pose P′ and current head pose P.

8. The method of claim 1, wherein the post rendering HRTF is personalized for a user of the user held processing device.

9. The method of claim 1, wherein the post-rendering metadata further includes an indication of the assumed head pose, P′.

10. The method of claim 1, wherein the method further includes transmitting an indication of the current head pose P to the main device, and estimating the assumed head pose P′ based on an expected transmission delay.

11. The method of claim 1, wherein the user held processing device comprises a wearable audio, visual, or AR device.

12. The method of claim 1, wherein the bitstream comprises an immersive audio and video services (IVAS) bitstream.

13. The method of claim 1, wherein said metadata includes a direction of arrival, DOA, associated with a dominant directional component of the immersive audio content, said DOA indicating the pre-rendering HRTF.

14. A system including one or more processors configured to perform the method of claim 1.

15. A computer program product configured to cause one or more processors to perform the method of claim 1.

16. A method of processing audio, comprising:
receiving a bitstream;
decoding the bitstream by a decoder to obtain decoded immersive audio content;
binauralizing the immersive audio content by a pre-renderer to generate a pre-rendered binaural signal, the binauralizing using a pre-rendering HRTF out of a set of HRTFs and an assumed head pose of a user;
encoding the pre-rendered binaural signal;
encoding post-rendering metadata, said metadata indicating the pre-rendering HRTF;
combining, in a multiplexer, the encoded binaural audio signal and the encoded post-rendering metadata, to form a bitstream including a binaural audio representation; and
transmitting the bitstream to a user held device.

17. The method of claim 16 wherein said metadata includes a direction of arrival associated with a dominant directional component of the immersive audio content.

18. The method of claim 16, wherein said metadata additionally includes said assumed head pose.

19. The method of claim 16, further comprising:
receiving an indication of a current user head pose from the user-held device, and determining the assumed user head pose based on the current user head pose.

20. The method of claim 16, wherein the method is performed in a smartphone.

21. A system including one or more processors configured to perform the method of claim 16.

22. A computer program product configured to cause one or more processors to perform the method of claim 20.

23. A user held processing device, comprising:
a decoder configured to decode a bitstream including a representation of a binaural pre-rendering of an immersive audio content, and to obtain a binaural audio signal and associated post-rendering metadata, said metadata indicating a pre-rendering HRTF used in the binaural pre-rendering, said pre-rendering HRTF associated with the assumed head pose;
a head-tracker for obtaining user head pose information indicating a current head pose;
a renderer configured to:
identify a post-rendering HRTF based on the metadata, the assumed head pose P′ and the current head pose P;
calculate a compensated stereo audio signal by applying an HRTF compensation operation, configured to compensate an effect of the pre-rendering HRTF, to the binaural audio signal; and
calculate a binaural output signal by applying said post-rendering HRTF to the compensated stereo signal.

24. The device of claim 23, wherein the HRTF compensation operation involves an inverse of the pre-rendering HRTF.

25. The device of claim 24, wherein the renderer is configured to obtain the inverse of the pre-rendering HRTF by accessing a look-up in a table comprising an approximation of an inverse of a pre-rendering HRTF.

26. The device of claim 24, wherein the renderer is configured to calculate a compensated stereo audio signal by:
applying an inverse left HRTF to a left channel of the binaural audio signal to form an inverse filtered left channel, applying an inverse right HRTF to a right channel of the binaural audio signal to form an inverse filtered right channel, and combining the inverse filtered left and right channels to form a left channel and a right channel of the compensated stereo audio signal, respectively.

27. The device of claim 26, wherein the inverse filtered left and right channels are linearly combined, with weights of the linear combining are selected to mitigate an error in a diffuse component of the binaural output signal.

28. The method of claim 27, wherein the weights are adaptive, preferably in response to a difference between assumed head pose P′ and current head pose P.

29. The device of claim 23, wherein the post-rendering HRTF is personalized for a user of the user held processing device.

30. The device of claim 23, incorporated into a wearable audio, visual, or AR device.
